(19) United States
(12) Patent Application Publication
(10) Pub. No.: US 2026/0235989 A1
(43) Pub. Date: Aug. 13, 2026

(54) WATCHCASE WITH ROTATING BEZEL

(71) Applicant: Comadur SA, Le Locle (CH)

(72) Inventor: Emmanuel JACQUOT, Grand'Combe-Châteleu (FR)

(73) Assignee: Comadur SA, Le Locle (CH)

(21) Appl. No.: 19/456,443

(22) Filed: Jan. 22, 2026

(30) Foreign Application Priority Data
Feb. 13, 2025 (EP) 25157807.6

(51) Int. Cl. G04B 19/28

(52) U.S. Cl. CPC G04B 19/286

(57) ABSTRACT

A watchcase (2) including: a ceramic middle (3); a bezel (4) rotationally fitted on a surface (5) of the middle; and a ball click (8) for indexing the position of the bezel (4) relative to the middle (3), the ball click (8) resting in a blind hole (9) in the middle (3). The ball click (8) includes a body (80) with a collar (82) arranged to rest on the surface (5) of the middle in the vicinity of the blind hole (9) receiving the ball click (8), and a distal end (81) resting near the back of the blind hole (9).

### CROSS REFERENCE TO RELATED APPLICATIONS

This application claims priority based on European Patent Application No. 25157807.6 filed on February 13, 2025, the entire contents of which are incorporated herein by reference.

### TECHNICAL FIELD

The present invention relates to a watchcase with a ceramic middle fitted with a rotating bezel.

### PRIOR ART

A commonly-used rotating bezel system is fitted with one (or more) ball click(s) designed to engage with the rotating bezel to enable the latter to be snapped into place. Snapping the rotating bezel into place in this way enables it to be precisely rotated on a watchcase middle, for example. If the middle is made of ceramic, it generally has a cylindrical outer rim with a blind hole for receiving the ball click. However, in this case, radii caused when the middle was machined are present in the back of the hole. These radii are unavoidable because they are generated by the milling cutters used to machine the blind hole. One problem that arises in such systems with ceramic middles is that when the ball click comes into contact with the radius or radii at the back of the hole, the ball click may no longer be positioned planish in the hole. This causes problems with variations in couple, slack and even mechanical fatigue between the parts, resulting in premature wear of the rotating bezel system.

### SUMMARY OF THE INVENTION

The present invention aims to remedy the aforementioned drawbacks by offering a watchcase with a ceramic middle fitted with a rotating bezel to ensure correct positioning via a ball click in the hole of a ceramic watchcase middle, thereby reducing mechanical wear of the parts and increasing the reliability and durability of the assembly.

To this end, the present invention relates to a watchcase comprising:

a ceramic middle; and

a ceramic bezel rotationally fitted on a surface of the middle; and

a ball click for indexing the position of the bezel relative to the middle, the ball click resting in a blind hole in the middle.

According to the invention, the ball click comprises a body with a collar arranged to rest on the surface of the middle in the vicinity of the blind hole receiving the ball click, and a distal end resting near the back of the blind hole.

According to other advantageous variants of the invention:

the collar has a diameter greater than the diameter of the blind hole.

the length between the collar and the distal end of the ball click is less than the length of the blind hole.

the distal end of the ball click is frustoconical.

the ball engages with a toothing on the bezel.

Other features and advantages of the present invention will become apparent in the following description of a preferred embodiment, presented by way of non-limiting example.

### BRIEF DESCRIPTION OF THE FIGURES

The purposes, advantages and characteristics of the invention will become more apparent from the following description, which is based on at least one non-limiting embodiment illustrated by the drawings in which:

FIG. 1 is a perspective view of a watchcase fitted with a rotating bezel system comprising a ball click according to the invention;

FIG. 2 is a cross-sectional view of the watchcase in FIG. 1;

FIG. 3 is a cross-sectional view of the watchcase fitted with a rotating bezel.

### DETAILED DESCRIPTION

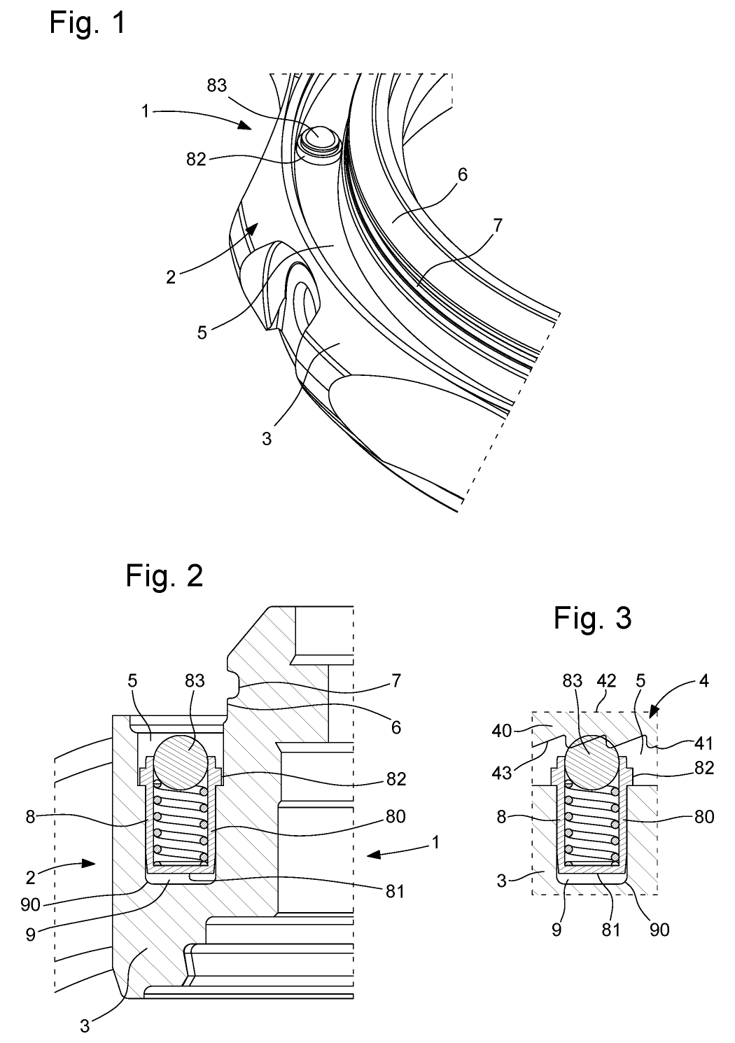

FIGS. 1 to 3 illustrate, by way of example, a watch 1 fitted with a watchcase 2. The watchcase 2 typically comprises a ceramic middle 3. The watchcase 2 also comprises a rotating bezel system 4 and a horology movement, the horology movement not being shown in the figures for the sake of clarity. The rotating bezel system 4 is rotationally fitted to the middle 3. Preferably, the rotating bezel system 4 is formed of a separate module.

As shown in FIG. 1, the middle 3 is annular in shape. The middle 3 comprises a cylindrical outer surface 6 that delimits a part of the middle 3 referred to as the chimney. The middle 3 also has an annular surface 5 on its cylindrical outer perimeter. As illustrated in FIGS. 1 and 2, the annular surface 5 is designed to receive at least one ball click.

The middle 3 can be made in one piece or can comprise several parts attached to each other, and has an annular surface 5 on one of its outer faces, typically the face intended to face away from the wearer's wrist when the watch is worn. As can be seen in FIG. 1, the annular surface 5 is formed by an annular groove.

The bezel 4 has a lower face 41, arranged to be positioned facing the annular surface 5 of the middle 3.

It should be noted that, in this text, “upper” and “lower” are defined relative to the orientation of the watch 1 when it is placed on a horizontal surface with the bezel 4 facing upwards.

In order to fasten the bezel 4 to the middle 3, at least one groove 7 is provided, the groove 7 forming axial locking means for the bezel 4 once the latter is in place on the middle.

The bezel 4 comprises a body 40, which takes the form of a hollow cap, the upper face 42 of which is intended to be visible to the user in the service position, and toothing 43, located on the lower face 41 of the body and fastened thereto. Alternatively, the bezel 4 can be made in one piece, with the toothing machined directly into its body.

The toothing 63 has a plurality of teeth defining a multitude of positions for the rotating bezel as it is moved clockwise or counterclockwise.

The angular position of the bezel 6 relative to the middle 3 is defined by at least one locking element, shown in this example in the form of a ball click 8 extending towards the surface 5. The ball click 8 is turned in a blind hole 9 formed in the annular groove.

The ball click 8 comprises a body 80 in which a spring is turned in, the body having a collar 82 arranged to rest on the surface of the middle in the vicinity of the blind hole 9 receiving the ball click. The ball click comprises a proximal end from which the ball 83 protrudes and a distal end 81 resting near the back of the blind hole 9. The collar 82 enables the ball click 8 to rest planish in the middle on the annular surface, the back of the hole 9 with radii 90 that keep the ball click 8 from being planar without the presence of the collar.

The diameter of the collar 82 is greater than the diameter of the blind hole 9, so that the ball click is securely held and stable at the hole 9.

It should also be noted that the length between the collar 82 and the distal end 81 of the ball click 8 is less than the length of the blind hole 9.

Advantageously, the distal end 81 of the ball click is frustoconical to make it easier to insert into the blind hole 9 when being fitted.

The ball click 8 engages with the toothing on the bezel to keep the bezel 4 from pivoting freely relative to the middle 3.

To keep the bezel in its operating position with no slack, several ball clicks 8 are provided.

The design of this rotating bezel system 4 on the ceramic middle 3 ensures that the ball click is correctly positioned in the middle and reduces mechanical wear on the parts, thereby increasing the reliability and durability of the assembly. The number of parts required is also reduced, and the rotating bezel is easy to fit to the middle.

1. A watchcase (2) comprising:
a ceramic middle (3);
a bezel (4) rotationally fitted on a surface (5) of the middle; and
a ball click (8) for indexing the position of the bezel (4) relative to the middle (3), the ball click (8) resting in a blind hole (9) in the middle (3),
wherein the ball click (8) has a body (80) with a collar (82) arranged to rest on the surface (5) of the middle in the vicinity of the blind hole (9) receiving the ball click (8), and a distal end (81) resting near the back of the blind hole (9).

2. The watchcase according to claim 1, wherein the collar (82) has a diameter greater than the diameter of the blind hole (9).

3. The watchcase according to claim 1, wherein the length between the collar (82) and the distal end (81) of the ball click is less than the length of the blind hole (9).

4. The watchcase according to claim 1, wherein the distal end (81) of the ball click (8) is frustoconical.

5. The watchcase according to claim 1, wherein the ball engages with a toothing (43) on the bezel (4).
